(19) United States
(12) Patent Application Publication
(10) Pub. No.: US 2025/0346306 A1
(43) Pub. Date: Nov. 13, 2025

(54) Aerodynamic Side Rail Fins for Freight Vehicles

(71) Applicants: Steven Todd Kron, Pewaukee, WI (US); Eric Thomas Kron, Pewaukee, WI (US)

(72) Inventors: Steven Todd Kron, Pewaukee, WI (US); Eric Thomas Kron, Pewaukee, WI (US)

(21) Appl. No.: 19/054,842

(22) Filed: Feb. 15, 2025

Related U.S. Application Data
(60) Provisional application No. 63/554,150, filed on Feb. 15, 2024.

(51) Int. Cl. B62D 35/00

(52) U.S. Cl. CPC B62D 35/001

(57) ABSTRACT

The purpose of this invention is to reduce the fuel consumption of heavy trucks by maximizing laminar flow alongside trailer walls. Fins extending from the bottom edge of the trailer side rail form a barrier between regions of high and low pressure, separating the turbulent air of the vehicle undercarriage and the more stable airflow above. Overlapping plastic forms with a flat surface are angled downward and outward and installed along the length of the vehicle. Through a tube fitted with a pipe, a fin is clamped to bars that span the gap between trailer crossmembers. Configured for comprehensive coverage fore to aft with limited lateral extent, this creates a streamlined aerodynamic profile. Its preservation of laminar flow is useful in insolation and increases the effectiveness of other fairings.

### BACKGROUND OF THE INVENTION

Of the factors influencing the fuel economy of semi-trucks, aerodynamics is the field which produces the most practical and profitable improvements. Of the two types of aerodynamic drag-friction and pressure-pressure drag has a particularly significant impact on heavy trucks, accounting for as much as 90% of drag force. On an unmodified tractor-trailer, approximately one third of this pressure drag is caused by the vehicle undercarriage.

Aerodynamic attachments can improve airflow over, under, and around the vehicle, thereby reducing drag and consequently fuel consumption. The conventional method is to simply shield the undercarriage using side skirts, which keep air alongside the trailer and away from numerous obstructions underneath. Side skirts are both relatively affordable and highly visible, allowing regulators, manufacturers, and fleets to demonstrate a minimum commitment to fuel efficiency.

As much as side skirts have benefited the trucking industry, their deficiencies should not be overlooked. These large surfaces ripple and wobble, losing energy to needless motion while propagating turbulence. They provide incomplete coverage, since side skirts do not span the full length fore to aft, nor the gap from the bottom of the trailer to the road surface. Most significantly, by increasing the effective size of a trailer, side skirts magnify the primary aerodynamic deficiency of a freight vehicle, that it is a large box creating a turbulent vacuum in its wake.

A concerning number of trailer wake devices do not span the full height of the trailer, so as to reduce manufacturing and maintenance costs. Such an apparatus might be made for the top two-thirds of the trailer when something closer to its full height will obviously be better, if not measurably so according to manufacturer data. If airflow along the lower third of the trailer is this turbulent, it should not be ignored but improved. While a trailer will leave behind a violent vacuum, we should nevertheless ensure that air entering this vacuum is flowing smoothly.

Despite the fundamental flaw of this big box, a trailer wall is inherently aerodynamic insofar as it is a broad, flat surface conducive to laminar flow. While side skirts leverage this principle, it is possible and preferable to promote smooth, stable airflow without adding significant bulk to a semi-trailer's aerodynamic cross-section. For example, the crossmember fittings of U.S. Pat. No. 8,550,541 transform the uneven underside of a trailer into a smooth surface yet yield a profile that is almost identical to the typical trailer.

While this streamlined profile opens the undercarriage to better targeted aerodynamic improvements, it also exposes airflow alongside the trailer to turbulence and suction from the relative vacuum underneath. Some form of barrier between the side of the trailer and the vehicle undercarriage is still warranted. Instead of a tall vertical extension, a short lateral protrusion can serve this purpose.

According to CFR § 658.16(b), tractor-trailers may exceed length and width determinations with “non-property-carrying devices” such as aerodynamic fairings so long as they “do not extend more than 3 inches beyond each side.” Working within this allowance, we will see substantial benefit from an outward angled surface extending from the bottom edges of the trailer. These side rail fins may seem too small a surface to make much impact, but along the full length of a 53′ trailer, which will travel hundreds of thousands of miles, a little improvement goes a long way.

### BRIEF DESCRIPTION OF THE DRAWINGS

FIG. 1. Perspective view of a semi-trailer, as seen from the front passenger side.

FIG. 2. Perspective view of a prototype side rail fin, warped by thermal expansion.

FIG. 3. Perspective view of segmented side rail fins with expansion joints, installed on a semi-trailer.

FIG. 4. Exploded view of the fin segment components, and assembled fin prepared for installation.

FIG. 5. Exploded view of an underside panel, an assembled underside panel, and an exploded view of the panel clamp components.

FIG. 6. Perspective view of a fin assembly secured to trailer crossmembers, as seen from above.

FIG. 7. Perspective view of a fin assembly secured to trailer crossmembers, as seen from below.

FIG. 8. Perspective view of the underside of a trailer, with side rail fins and complementary fairings installed.

FIG. 9. Profiles and perspectives of prospective fin extrusions.

### SUMMARY OF THE INVENTION

The invention is an aerodynamic outward extension from the side rail of a freight vehicle. This forms a barrier between volumes of differential pressure, isolating the turbulence underneath the trailer from laminar airflow alongside. To limit cost and maximize resilience, the fins are fabricated from extruded plastic. To overcome the effects of thermal expansion, this is machined into smaller segments. While they are mounted independently of one another, the fins form a substantially continuous surface from the front to the rear of the vehicle.

Made with minimal modification in mind, these fins are not attached straight to the trailer but fastened to another element that is also indirectly secured. Through a hollow tube, a fin is fitted with a pipe, which is clamped to bars that span the gap between crossmembers. This tube reduces the risk of damage as fins are more likely to rotate around the pipe than to break off at a mounting point. The bar connection also supplies structural support to aerodynamically compatible crossmember covers.

Not only is preservation of laminar flow beneficial in insolation, these side rail fins will also increase the effectiveness of other fairings. Crossmember covers, which create a continuous smooth surface on the uneven underside of the trailer, do nothing to shield its sides from suction. When these diagonal fins and rectangular panels are used in tandem, they promote stable airflow along all sides of the trailer. This provides a platform for additional aerodynamic advancements, pulling off the bandage of side skirts and pushing an abandoned problem closer to a solution.

In practice, the invention has yielded notable results, both quantitative and qualitative. Side rail fins have improved the fuel efficiency of what was already an industry-leading system for semi-trailers. Smooth, stable airflow also visibly enhances safety, reducing road spray and improving driving conditions for all adjacent motorists during inclement weather. One observation in particular testified to the stability of this airflow, as was seen a stray sheet of paper in portrait orientation in suspension just above the side rail fins. It carried along in this uniform way before wrapping smoothly around the rear of the vehicle.

### DETAILED DESCRIPTION OF THE PREFERRED EMBODIMENT

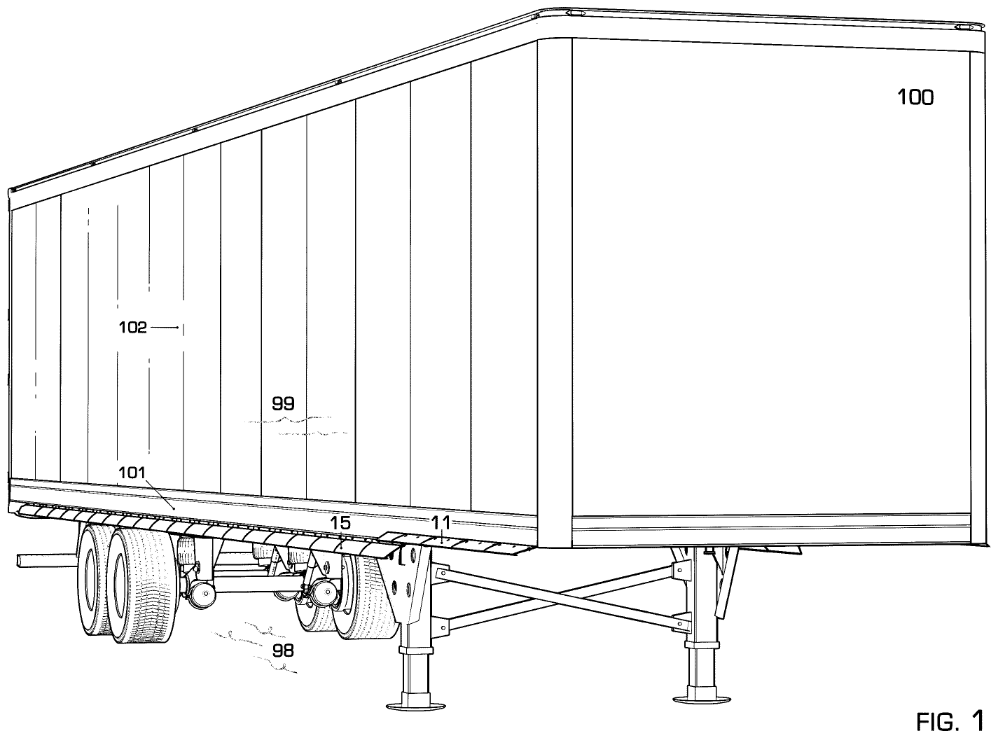

The preferred embodiment comprises a series of overlapping fins installed along the bottom edge of a semi-trailer, from front to back as illustrated in FIG. 1. Each fin is at least 2 feet long. Their total width is approximately 6 inches but, with some of this surface required for mounting and the remaining dimension determined by regulations, not much more than two-thirds protrude past the trailer. Fins extend outward at a downward angle from the side rail to form a barrier between ventral airflow and lateral airflow, so that they are distinct volumes with differing pressures and fluid characteristics. This isolates turbulence below the trailer and preserves laminar flow alongside its walls. While a fin that is oriented vertically may have a minor impact, those positioned parallel to the trailer walls will not have an appreciable effect.

A fully horizontal fin, perpendicular to a trailer side rail, will achieve our purpose. As effective as this may be, the exclusions from length and width determinations as set forth in CFR § 658.16(b)(2)(ii) restrict additional width to 3 inches on either side. Consequently, the dimensions of a horizontally oriented fin cannot exceed this measurement. Angled downward 45° from horizontal, this fin may measure 4¼ inches, increasing the deflecting surface 11 by 40% while adhering to regulations.

Furthermore, a 45° angle for this fin increases the vertical dimension of the laminar flow region 99 by approximately 2.5% in the case of the typical trailer with walls 8½ feet in height. If this dimension is evaluated relative to the problematic lower third, that therein transpires the targeted turbulence, then the downward angled fin forms a laminar flow volume that is closer to 7% greater in height. Whatever the extent of this increase, it not only preserves laminar airflow alongside the trailer walls 102 but expands its envelope beyond the lower edge of the side rail 101.

In addition to any aerodynamic benefits, we ought to consider the purpose of these length and width determinations, which is to minimize the risk and result of collision with other motorists and structures. A downward angled fin is better positioned to yield, absorbing impact across the deflecting surface, whereas a horizontal fin is oriented perpendicular to oncoming force such that damage is more likely. For a multitude of reasons, the angled fin configuration is preferred.

That said, certain sections of the trailer favor a horizontal orientation of the fin 15 and its deflecting surface 11. At the front of the trailer, for instance, clearance is a much greater concern, since it sits mere inches above the tractor frame. As such, suction is less significant since the void underneath the trailer is occupied by the tractor. At the same time, the tractor is a source of turbulence, exhibiting exposed elements and moving parts that disrupt stable airflow. A horizontal fin is sufficient to isolate this turbulence beneath the trailer.

While variations will be required or preferred under certain circumstances, the following fin assembly 27 applies as is along 80% of a 53-foot side rail. In short, a fin 15 is clamped to bars 34 on panels 30 that are secured to crossmembers 77. Multiple fins are installed such that they overlap and form a substantially continuous surface from the front to the back of a trailer 100 extending outward from the bottom edge of its side rail 101. This creates a barrier between the lateral laminar flow volume 99 and the ventral turbulent flow volume 98.

The fin itself comprises two key features, a cylindrical mounting tube 12 and a flat deflecting surface 11. Additionally, a lengthwise lip 13 lends improved strength and increased uniformity. All these elements are present in off-the-shelf garden edging, as described in the Divider and Sprinkler Combination of U.S. Pat. No. 3,387,786. When these parts serve their intended purpose, the round tube provides for the passage of water, the flat flange is a barrier to root growth, and the lengthwise lip is meant for stakes to secure a piece in place. This garden edging is still produced by the original patent holder Valley View Industries, as an extruded form composed of medium density polyethylene with UV inhibitor and cut to 20-foot lengths.

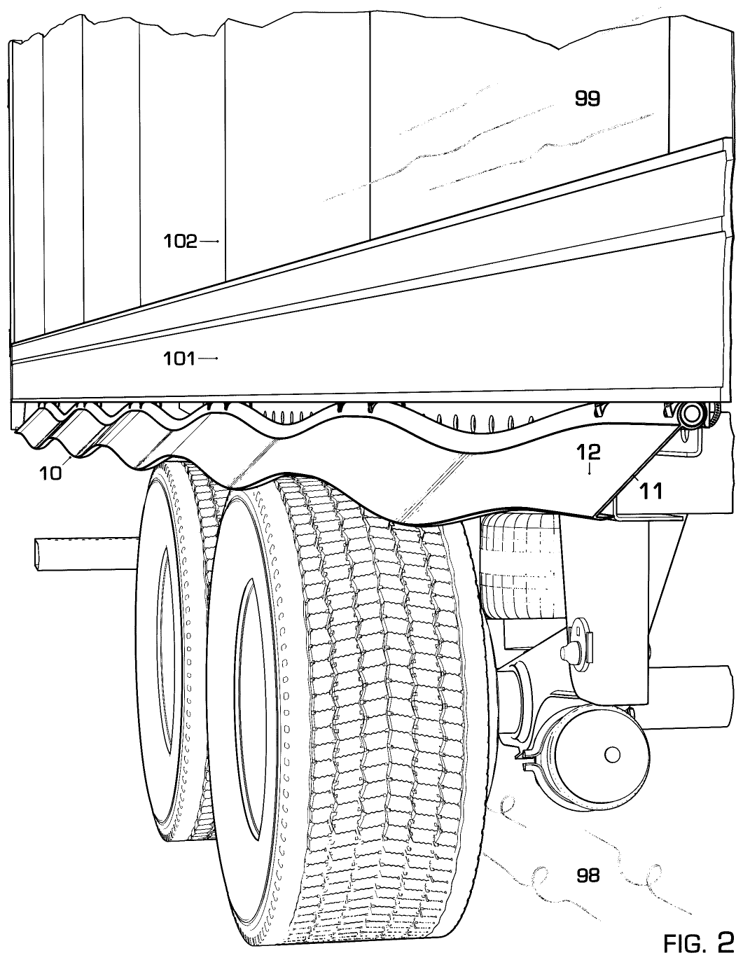

A bespoke extrusion is preferred, but plastic garden edging was nevertheless useful for prototyping and is sufficient for production. However, repurposing the full-length extrusion presented several challenges during installation and resulted in cosmetic and aerodynamic deficiencies in the completed assembly. As shown in FIG. 2, thermal expansion of the extrusion 10 produced profound undulations in a once flat form. Once a trailer is on the highway, air rushing over the extrusion reverses this thermal expansion, but the fairing still suffers diminished effectiveness until its original shape is restored. Furthermore, with such significant warping, repeated expansion and contraction might compromise the durability of the material.

Apart from this glaring issue, there are other downsides to the extended extrusion construction. Larger pieces of material are more cumbersome to handle, slowing the installation process. And the longer a piece is, the more likely some section does not meet specification. On the trailer itself, there will be inconsistencies in crossmember spacing, which even without additional introduced errors may prevent precisely machined apertures from aligning with mounting points.

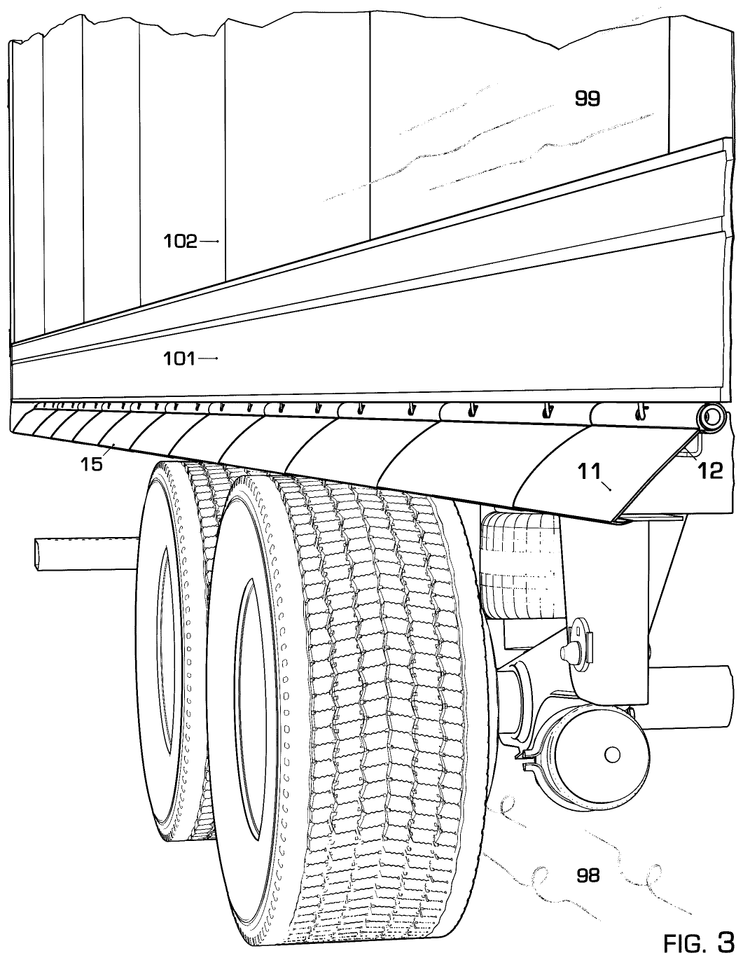

All these issues can be addressed by implementing a series of shorter segments, as illustrated in FIG. 3. In the preferred embodiment, segments 15 are machined to increments of one foot, such that they equal the spacing between trailer crossmembers. The typical fin is 2 feet in length. This will have a tube length of 23⅞ inches for an expansion joint of ⅛ inches. While the tube 12 is slightly shorter than the space they span, segments form a continuous fairing as the flat surface 11 of each fin overlaps the adjacent fin with a small semi-circular flap. This flap faces backward rather than forward, so that oncoming air will not flow into its edge or under its surface.

This rearward extension of the fin 15 could be any shape and size, so long as it covers the expansion joint. Ideally, it is smaller to save material and rounder to maximize aerodynamic effectiveness. The trapezoidal tail of the original prototype was suboptimal, with the same shape shown in a shadow of residual dirt, a telltale sign of turbulence. A half-circle is larger than required and its arc might not be machined tangent to the edges of an inconsistent material, presenting a pointless quality control concern. For these reasons, the preferred shape is one-third of a circle.

An individually molded piece would have much the same shaping and, given the relatively small size of this highly repeatable piece, injection molding may become the preferred manufacturing method. One benefit of an extruded form 10, however, is that it can be machined to varying lengths to suit a section which does not correspond to such regular repetition. For example, deliberately different spacing of the trailer crossmembers 75 will require a variant configuration.

While a segment 15 that is 2 feet in length is suited to the better part of a trailer, something slightly shorter or longer is sometimes necessary. Furthermore, segments of extended length can be twisted around the axis of the pipe 20, as to dovetail into an accompanying fairing, improving overall flow and fit. With that said, the longer the fin the more cosmetic imperfections and structural variations are manifest, so something shorter than four feet is recommended.

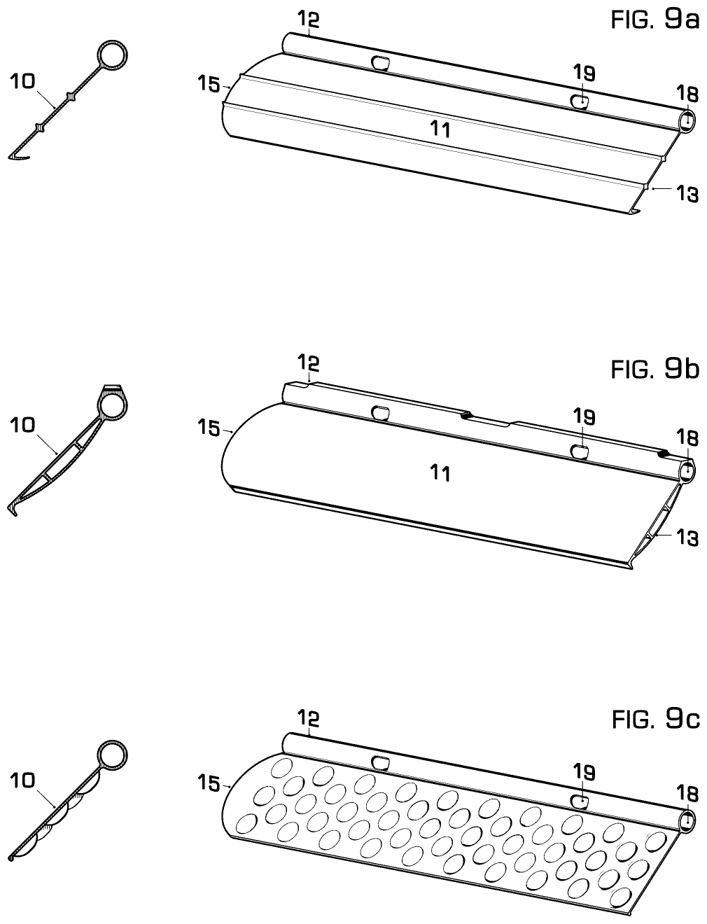

While the extant extrusion succeeds, there is room for improvement with respect to these imperfections and variations. The basic shape is sufficient, but more features may add strength and structure. These alternative fin designs and their extrusion profiles are illustrated in FIG. 9. As shown in 9A, an otherwise identical fin could be adorned with lengthwise ridges. By employing a similar method of lengthwise reinforcement, as in 9B, we will support a second surface via internal structure, such that the fin has both top and bottom sections. Beyond that, a flat top could supply strength to the tube, being both a surface that sets the mounting angle and a bulwark against mounting pressure. Certainly, the stamped dimples depicted in 9C would also improve uniformity and further reduce drag.

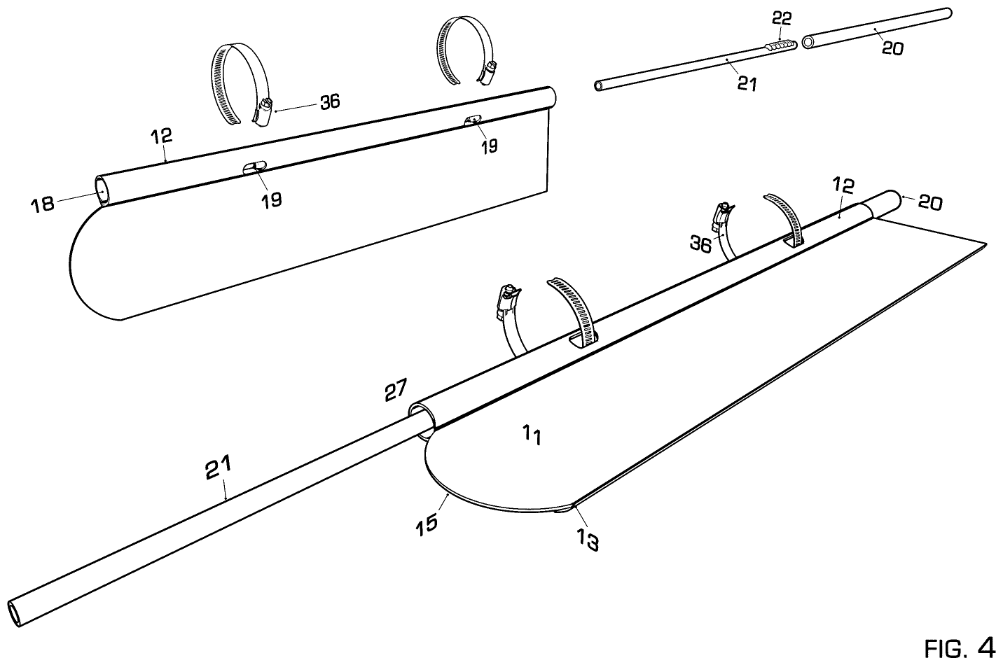

As to the matter of mounting these fins in place, the fin is fitted with a pipe which is secured with hose clamps. This fin assembly 27 is prepared for installation as illustrated in FIG. 4. First, an alignment pipe 21 is attached to a mounting pipe 20 with construction adhesive 22. The mounting pipe is equivalent in length to the fin tube 12. The alignment pipe is slightly shorter, but protrudes approximately one foot from the mounting pipe once they are fused together. When installed, the alignment pipe from one assembly fits together with the mounting pipe of the subsequent segment in the series.

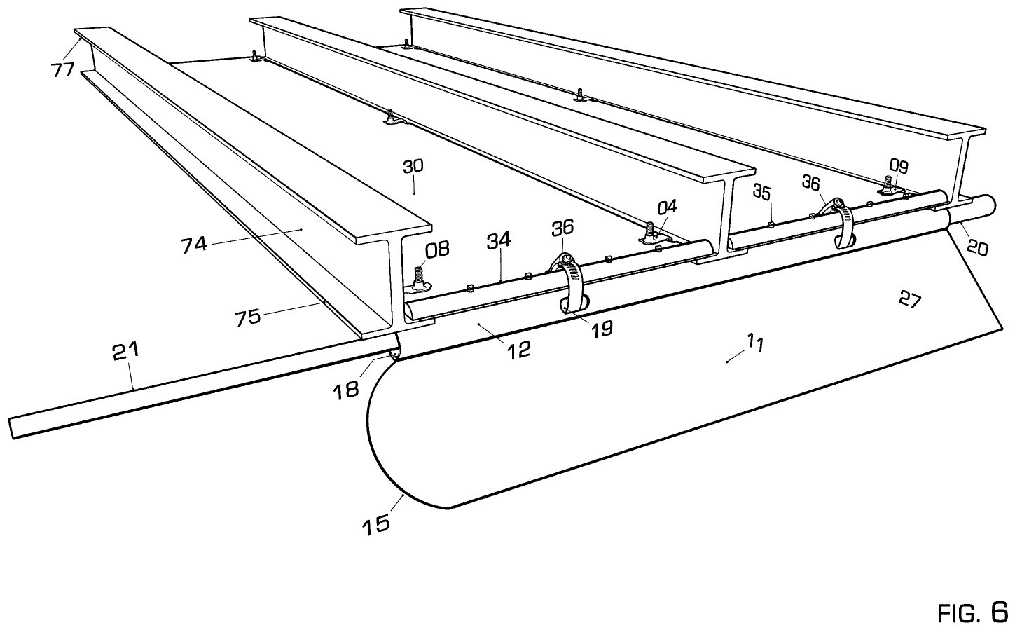

As depicted in FIG. 6, the mounting pipe 20 juts out roughly 3 inches in front of the fin tube 12 through hole 18, while the alignment pipe 21 sticks backward about 8 inches. Each pipe assembly is integrated into multiple fin segments, maximizing their connection to the trailer and improving continuity from fin to fin. This configuration makes it unlikely a fin would fall off, even in the absence of clamping force. More importantly, it aligns all fins along a unified axis. That they together form a substantially continuous surface is a crucial aspect of their segmented construction, so ensuring everything is pointed in a consistent direction is just as important as closing gaps between fins. While a pipe suspends the fin, hose clamps secure the whole assembly in place.

The tube 12 has two pairs of slots 19 spaced one foot apart such that they coincide with the spacing between trailer crossmembers 77. Each clamp slot pair comprises a medial and lateral slot, which are the insertion points for the band of a hose clamp 36. These slots are positioned on the lower half of the tube so that this band slips underneath the pipe 20. For a tube with an outside diameter of 1⅛ the slot measures just under ½ inch tall and just over 1 inch long.

The basis for these dimensions is they allow for minor deviations within crossmember spacing, as well as sufficient width for the hose clamp, while removing a minimum amount of material. Retaining the top of the tube rather than cutting away its full circumference helps to preserve the structural integrity of the extruded form 10. Improved sturdiness reduces the presence of defects such as pinching, buckling, and warping which might manifest at mounting points. This slot configuration limits clamping force to the rigid polyvinyl chloride pipe 20, relieving pressure on the softer polyethylene tube 12.

The installed fin assembly is shown in FIG. 6, with hose clamps 36 fastened around half round bars 34. One of these bars spans greater than the distance between the crossmember flanges 75 but less than the distance between the crossmember I-beams 74. In particular, this aluminum half round bar measures 11⅛ inches in length and has a diameter of ¾ inches. While one a full inch in diameter may seat the hose clamps slightly better, it would do so at higher cost and a 75% increase in weight.

In the preferred embodiment, the bar is indirectly secured to the crossmembers. The initial prototype was based on an intricately machined angle which was riveted to the crossmembers themselves, a process and result with multiple disadvantages. Production of this piece proved much slower, even when automated. Drilling through the steel crossmembers is laborious and could not be offloaded to machines. Most importantly, modifications to these critical structural elements should be avoided. For these reasons, fewer bars were used, leaving large gaps in the support system which did not hold up under the effects of thermal expansion.

There should be a half round aluminum bar 34 in between each crossmember pair, such that each fin segment 15 is supported from at least two points of attachment. While it would be possible to rivet each bar in place, this is too time intensive. A reasonable alternative is that the bars rest on top crossmember flanges 75 and are held in place once unified with the fin assembly 27 via hose clamps 36. The most convenient and secure connection is achieved by adapting Inventor's prior art, the Aerodynamic Fittings for Trailer Crossmembers of U.S. Pat. No. 8,550,541 B1.

These aerodynamic fittings take the form of flat panels spanning the gaps between trailer crossmembers. Crossmember covers create a smooth surface conducive to laminar flow where once was an uneven underside. As a major objective of our approach is opening avenues of airflow, crossmember covers and side rail fins are not only compatible, but the combination is necessary to maximize their effectiveness. Their synthesis will also supply mutual structural support.

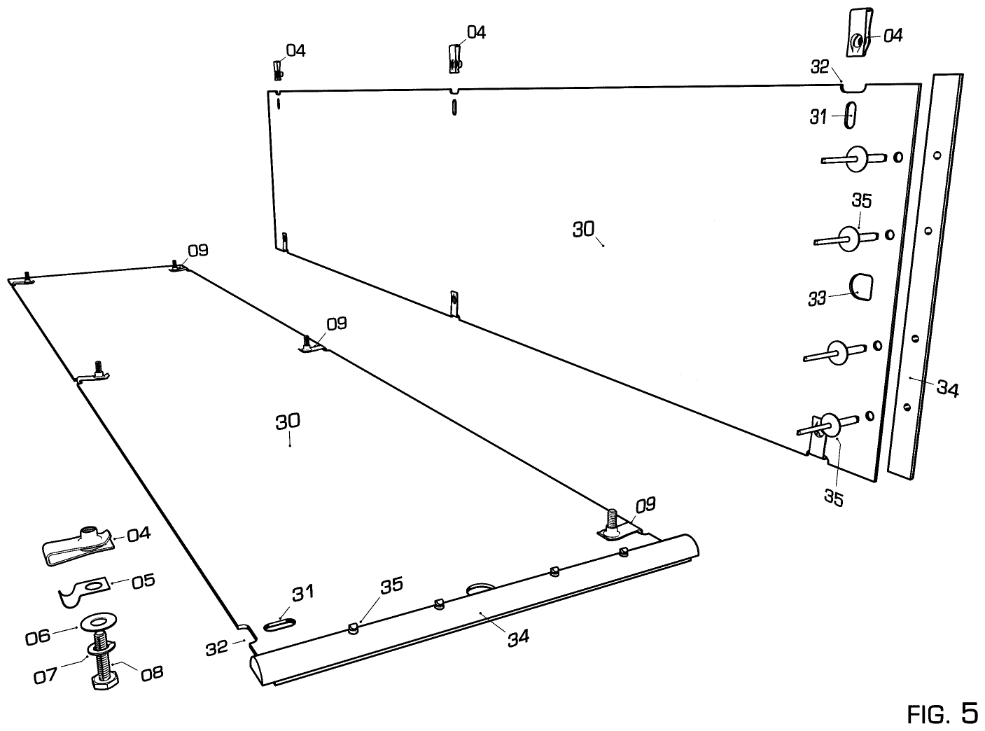

As shown in FIG. 5, the half round bar 34 is riveted to the outside edge of a glass fiber reinforced plastic panel 30. With the bar placed on the top of the panel and rivets 35 inserted from the bottom, this mounting surface is fixed to the panel so that it may be indirectly attached to the trailer. To the medial side of the bar, flush with its edge, there is an aperture 33 to accommodate a hose clamp 36. Apart from providing a mounting point, the bar supplies strength and stability to these flexible panels, which facilitates installation. The addition of a rigid body yields increased consistency when placing panels, improving handling and reducing difficulty in less accessible spaces.

The width of the panels is less than the center-to-center distance between crossmembers and greater than the space between their respective flanges, such that a panel 30 more than spans the gap between crossmembers 77. For panels fitted to crossmembers with a center-to-center distance of one foot, these panels should measure between ten and eleven inches wide, with the optimal width being 10% inches.

These panels are held in place with a plurality of clamps, comprising a U nut 04, a half clip 05, a washer 06, a lock washer 07, and a bolt 08. Shown in FIG. 5, the U nuts fit on the edge of a panel along indentations 32 and over slotted holes 31. These slotted holes allow for the U nuts to be slid in or out relative to the edge of the panel, effectively increasing or decreasing the width of the assembly to account for variance in crossmember spacing. The crosswise indentation paired with each slotted hole is an additional element developed since the original filing to further increase compatibility.

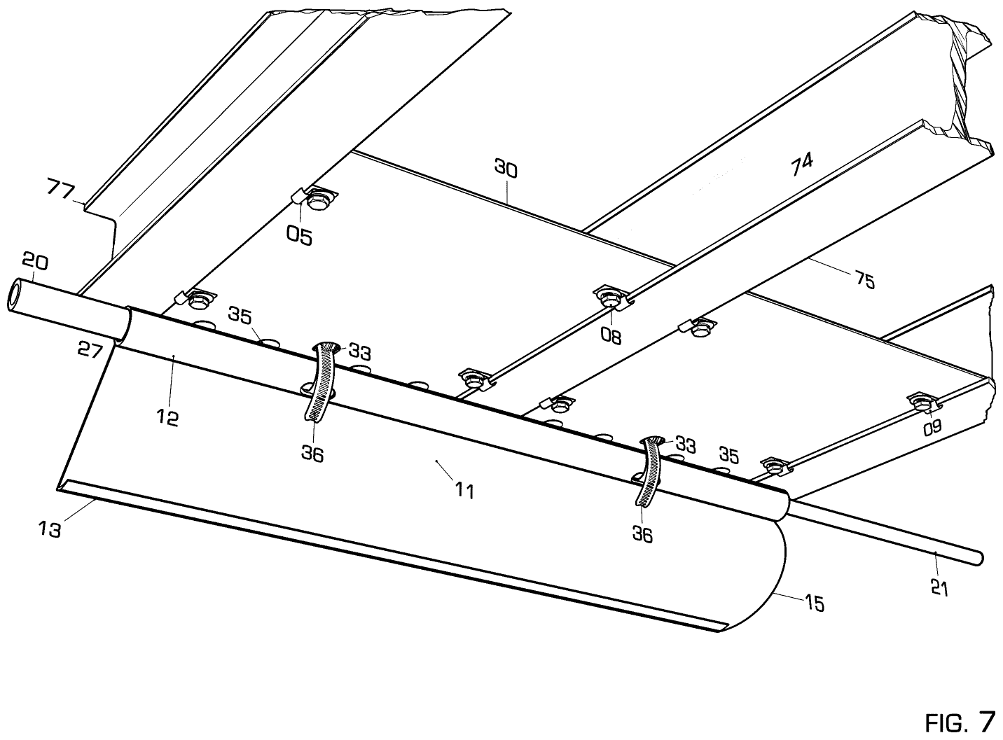

Once panels 30 are fitted with U nuts, preliminary assembly of the clamps can begin. Below each U nut 04, the clamp is completed with a half clip 05, a washer 06, a lock washer 07, and a bolt 08. Following this procedure, the panel is placed in between crossmembers 77 such that it rests on top of crossmember flanges 75. With a U nut on the topside of the flange and a half clip on the underside, tightening the bolts secures the panel in place. As illustrated in FIG. 7, the U nut is flush to the flange while the half clip is flat against the U nut, but with a band that wraps around the flange to grip the bottom of the crossmember.

This provides the perfect platform to place a mounting bar, as it is secured to the trailer without even the most minor modification to the crossmembers. With the hose clamp 36 under the mounting pipe 20, around the tube 12, over the bar, and through an aperture 33 at the end of the panel 30, the side rail fins and crossmember covers are unified. While either may be mounted separately, clamping them together increases the number of connection points and strengthens the security of all parts in the assembly. Best of all their aerodynamic utility, which is the purpose of these inventions, will be greatly enhanced when they are used in tandem.

Once fin assemblies are positioned at an appropriate angle, hose clamps can be tightened, followed by panel nuts and half clips. With everything secured, that leaves a few finishing touches. Excess length of band from hose clamps 36 should be tucked into tube slots 19. If the panels 30 are warped or buckled, cable tie tension between a panel pair may work out these kinks.

It is also important to address areas where there are not exposed crossmembers. This will require a different method of mounting. At the front of a semi-trailer, the area around the king pin plate is flat sheet metal, which may or may not have lightening holes. While these apertures offer a means of mounting, with aluminum sheets sandwiched above and below the plate, some drilling and riveting will be required. From one trailer to another, there will be more variation in this plate than in crossmember configuration, but more conventional connections will cover assembly.

With the space between the crossmembers covered and the sidewalls shielded from suction, most of these surfaces are made conducive to laminar flow. One area which we have yet to address is the descent from the bottom of the trailer to the rear. The crossmember configuration changes from I beams to square tubes as they drop down roughly 4 inches to the buckplate. A fairing formed as a concave to convex curve will allow air to undergo this descent with a minimum of turbulence.

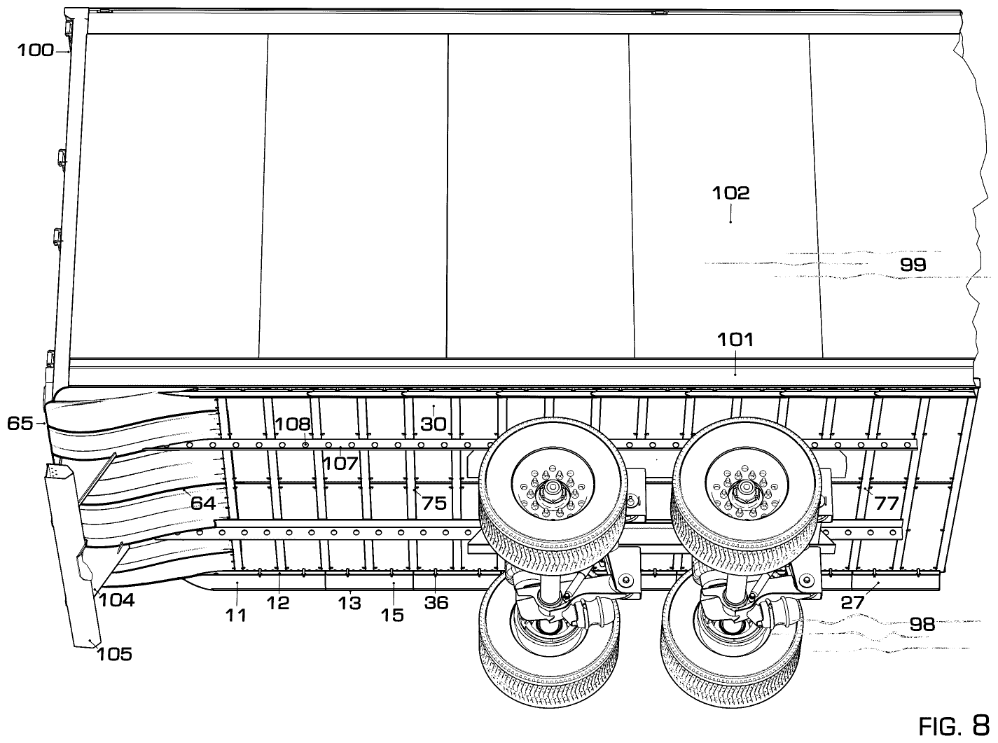

As shown in FIG. 8, an aft fairing comprising vacuum formed plastic segments 64 takes such a shape. These modular segments, cut to roughly 2 feet in width, are just under 4 feet in length with a height of 6 inches. Their finished length is based on the distance from the rear of the trailer to the crossmember flange where each module will be attached. The mold is reinforced by grooves spaced 8 inches apart, with a width of 1½ inches. These grooves are as deep as ½ inches, but taper from zero depth or otherwise intersect the above obstructions. They also taper to zero, such that the trailing edge is flush to the base of the buckplate.

The tapered grooves also allow the front of the fairing flexibility, enabling it to accommodate varying pitches and resulting differences between molded and mounted dimensions. At the leading edge, this fairing is secured to the trailer in the same manner as the panels 30, with clamps 09 over slotted holes 31. To support greater size and strain, there are three to four times as many clamps in the same span. As the molded forms do not rest entirely on the crossmembers, they are suspended by a pipe spanning the width of the trailer through holes 108 in the slider tracks 107. The rotation of this pipe can be used to fine tune the slope of the fairing before it is fastened in place.

The slope descends beneath the bottom of the buckplate such that the convex curve is pitched upward to the back of the trailer with an outgoing angle of 30 degrees. More embellished contours are best suited to the middle of the fairing where air pressure is lowest. With the center sections flanked by bumper support pylons 104 no shape will pose further obstruction, whereas the edge profile must be minimal to allow airflow. Along the outside edge, the corner fairing 65 features a shallower shape closer in cross-section to the trailer itself. As this arcs gradually to match the more dramatic contour of the medial modules, it rounds off the bottom corner of the trailer.

Where this fairing is present, it is advantageous to allow air underneath so that the aft vacuum is filled efficiently from all sides. This informs the design of the rear segments for the side rail fins. Depending on the configuration of the trailer, it may be favorable for the final fin to end in advance of the aft fairing, so that at this point it provides no barrier to airflow. The fins could fold down and curve inward, compressing the ventral volume and guiding flow to the center. The option which meets the most objectives is for the fin to twist upward to a horizontal orientation. This way, it maintains continuity all the way aft and allows additional airflow while retaining the barrier to turbulence.

So long as laminar flow forms an envelope from floor to roof, the side rail fin is a success. At the rear of the trailer the force of suction from the aft vacuum surpasses the effect of the pressure differential between the lateral and ventral volumes. Under these conditions, the fin may have minimal effect on the exact egress of air beyond the trailer walls, but the cumulative effect across the vehicle is significant. Maximizing the presence and persistence of laminar flow along the full length of the trailer makes a massive impact on fuel consumption. Achieving this effect with such streamlined profiles will further future improvements to fuel efficiency.

What is claimed is:

1. A rail fin for a freight vehicle:
wherein said freight vehicle has a trailer comprising an aft section, wherein said trailer comprises a wall and a side rail on either side of the trailer, with a plurality of crossmembers spanning from one side rail to the other side rail;
wherein said rail fin is a substantially flat fairing attached to said trailer at a bottom edge such that the rail fin extends lengthwise along the side rail;
wherein said rail fin protrudes outward from the bottom edge of said trailer such that there is a lateral airflow volume above the rail fin and a ventral airflow volume below the rail fin;
wherein said lateral airflow volume is adjacent to said wall and said side rail, wherein said ventral airflow volume is below said plurality of crossmembers, and wherein said substantially flat fairing forms a barrier between the lateral airflow volume and the ventral airflow volume.

2. The rail fin of claim 1, wherein said substantially flat fairing is angled downward such that the angle between said trailer and said rail fin is greater than 90° and less than 150°.

3. The rail fin of claim 1, wherein said substantially flat fairing is horizontal such that the angle between said trailer and said rail fin is approximately 90°.

4. The rail fin of claim 1, wherein said substantially flat fairing is attached to said trailer at an opposite edge such that there is a rail fin on either side of the trailer.

5. The rail fin of claim 1, wherein said rail fin comprises a series of fin segments, wherein said fin segments overlap and form a substantially continuous surface.

6. The fin segments of claim 5, wherein said fin segments are machined from a profile extrusion of arbitrary length.

7. The fin segments of claim 5, wherein said fin segments are molded to a specific shape and size.

8. The fin segments of claim 5, wherein said fin segments comprise a mounting tube and a deflecting surface;
wherein said deflecting surface is a planar protrusion towards the distal edge of said fin segments;
and wherein said mounting tube is a hollow surface on the proximal side of said fin segments.

9. The mounting tube of claim 8, wherein said mounting tube has a tube hole on either end such that said mounting tube fits a pipe assembly.

10. The pipe assembly of claim 9, wherein said pipe assembly comprises a mounting pipe and an alignment pipe;
wherein said mounting pipe is smaller in diameter than said mounting tube, and wherein said mounting pipe is larger in diameter than said alignment pipe;
wherein said alignment pipe is affixed to said mounting pipe such that said alignment pipe protrudes from said mounting pipe.

11. The mounting tube of claim 8, wherein said mounting tube has at least two slot pairs, wherein a slot pair comprises two oblong holes;
wherein a first oblong hole is through a medial side of said mounting surface and a second oblong hole is through a lateral side of said mounting surface such that the two oblong holes of said slot pair are opposite one another.

12. The series of fin segments of claim 5, wherein a fin assembly is comprised of the fin segment of claim 8 and the pipe assembly of claim 9.

13. The fin assembly of claim 12, wherein said pipe assembly fits inside the mounting tube of said fin segment.

14. The fin assembly of claim 12, wherein said fin segment and said pipe assembly are held together by at least two hose clamps, wherein said at least two hose clamps are fed through said at least two slot pairs, and wherein said at least two hose clamps wrap around said pipe assembly and said mounting tube.

15. The fin assembly of claim 14, wherein said fin assembly is attached to the trailer with said at least two hose clamps via at least two bars, wherein a bar is one of the following: flat stock, angle stock, or a half-round bar;
wherein said bar spans the distance between two crossmembers, wherein said crossmembers are two of the said plurality of crossmembers spanning from one side rail to the other side rail;
and wherein said bar sits atop an I-beam flange on either of said two crossmembers.

16. The fin assembly of claim 15, wherein said at least two hose clamps secure said fin assembly on below said plurality of crossmembers via said pipe assembly, and above said plurality of crossmembers via said at least two bars.

17. The two crossmembers of claim 15, wherein any two crossmembers are separated by an approximate standard spacing, wherein said approximate standard spacing is 12 inches.

18. The approximate standard spacing of claim 17, wherein said slot pairs are separated by a measure equal to said any two crossmembers separated by said approximate standard spacing.

19. The approximate standard spacing of claim 17, wherein said mounting tube is slightly lesser in length than said approximate standard spacing;
and wherein said pipe assembly is substantially greater in length than said mounting tube, such that an alignment from one fin assembly protrudes into a mounting pipe from an adjacent fin assembly.

20. The deflecting surface of claim 8, wherein said deflecting surface is greater in length than said mounting tube, such that the deflecting surface overlaps an adjacent mounting surface.

21. The deflecting surface of claim 8, wherein said deflecting surface has at least one of the following structural reinforcements: a distal lip, a surface protuberance, a surface indentation, or an internal rib.

22. A secondary mounting surface comprising:
at least one panel nested in between trailer crossmembers and a plurality of clamps that secure said panel to said crossmembers;
wherein said clamps comprise a U nut and a clamping element, wherein said U fits over the edge of said panel and wherein said clamping element has an aperture and a gripping surface;
and wherein said clamps secure said panel to the lower flanges of said crossmembers, with said U nut on the top surface of a flange and said clamping element pressed against the bottom surface of said flange, such that said flange is clamped in between said U nut and said clamping element.

23. The secondary mounting surface of claim 23, wherein said clamping element is chosen from the following: half clips, beveled washers, and fender washers.

24. The secondary mounting surface of claim 23, wherein said clamps are further comprised of a washer and a lock washer.

25. The secondary mounting surface of claim 23, wherein said clamps are bolted to said panel through slotted holes, and wherein each of said slotted holes is paired with a notched indentation at the edge of said panel.

26. The secondary mounting surface of claim 23, wherein there is one panel on either side, and wherein said panels combine to span the entire width of said trailer.

27. The secondary mounting surface of claim 23, wherein there is a bar at the lateral edge of said panel, wherein there is a clamp aperture to the medial side of said bar, such that a hose clamp can pass through said clamp aperture and around said bar, and wherein said hose clamp can secure a fairing to said bar.
